(19) United States
(12) Patent Application Publication
(10) Pub. No.: US 2024/0367612 A1
(43) Pub. Date: Nov. 7, 2024

(54) METHODS AND SYSTEMS FOR VEHICLES

(71) Applicant: Toyota Motor North America, Inc., Plano, TX (US)

(72) Inventors: Cindy Kim, Los Angeles, CA (US); Imad Zahid, Carrollton, TX (US); Allen Danklefsen, Round Rock, TX (US); Daniel Holman, Allen, TX (US); Dany Benjamin, Rowlett, TX (US); Ian Evans, Murphy, TX (US); Felipe Salles, Carrollton, TX (US); Eric Bursch, Ann Arbor, MI (US); Melody Ayeli, Richardson, TX (US)

(73) Assignees: Toyota Motor North America, Inc., Plano, TX (US); Toyota Jidosha Kabushiki Kaisha, Toyota-shi (JP)

(21) Appl. No.: 18/312,876

(22) Filed: May 5, 2023

(51) Int. Cl. B60R 25/31; B60R 25/10; B60R 25/24; B60W 60/00

(52) U.S. Cl. CPC B60R 25/31; B60R 25/1001; B60R 25/241; B60W 60/00253

(57) ABSTRACT

Methods and systems for a vehicle are provided. The method includes receiving identification data of an object outside of the vehicle from an identification recognition unit, acquiring authorization data associated with an occupant in the vehicle, determining the object is authorized to pick up the occupant based on the identification data and the authorization data, and unlocking a door of the vehicle in response to determining that the object is authorized to pick up the occupant.

### TECHNICAL FIELD

The present disclosure relates to operation of vehicles and, more particularly, to remote operation of vehicles.

### BACKGROUND

As background, autonomous vehicle technology is developing increasingly, but distrust is a potential obstacle to consumer acceptance of autonomous vehicles. Remote operation of vehicles may aid operation of autonomous vehicles and may improve security, reduce liability issues, and create new services.

### SUMMARY

In accordance with one embodiment of the present disclosure, a method includes receiving identification data of an object outside of a vehicle from an identification recognition unit, acquiring authorization data associated with an occupant in the vehicle, determining the object is authorized to pick up the occupant based on the identification data and the authorization data, and unlocking a door of the vehicle in response to determining that the object is authorized to pick up the occupant.

In accordance with another embodiment of the present disclosure, a system includes a processor configured to perform a method. The method includes receiving identification data of an object outside of a vehicle from an identification recognition unit, acquiring authorization data associated with an occupant in the vehicle, determining the object is authorized to pick up the occupant based on the identification data and the authorization data, and unlocking a door of the vehicle in response to determining that the object is authorized to pick up the occupant.

Although the concepts of the present disclosure are described herein with primary reference to user-driven automobiles, it is contemplated that the concepts will enjoy applicability to any vehicle, user-driven or autonomous. For example, and not by way of limitation, it is contemplated that the concepts of the present disclosure will enjoy applicability to autonomous automobiles.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A depicts an exemplary embodiment of a system, according to one or more embodiments shown and described herein;

FIG. 1B depicts a schematic diagram of the system of FIG. 1A comprising a vehicle and a server, according to one or more embodiments shown and described herein;

FIG. 2 depicts a schematic diagram of the vehicle of FIG. 1B, according to one or more embodiments shown and described herein; and

FIG. 3 depicts a flowchart of a method that may be performed by the vehicle and/or server of FIG. 1B, according to one or more embodiments shown and described herein.

### DETAILED DESCRIPTION

The embodiments disclosed herein include methods, systems for vehicles for providing an authentication system. In embodiments disclosed herein, a vehicle may have an identification recognition unit that may detect and identify an object outside of the vehicle approaching the vehicle. When the object is determined to be authorized to pick up an occupant inside the vehicle, a door of the vehicle is unlocked to allow the object to have an access to the occupant. The authentication system may keep the occupant secure from unauthorized attempt to retrieve the occupant. The embodiments disclosed herein are particularly helpful when the occupant may not be able to protect him/herself or to recognize the object to determine whether to open the door of the vehicle. The embodiments disclosed herein may be used with additional features further enhancing security.

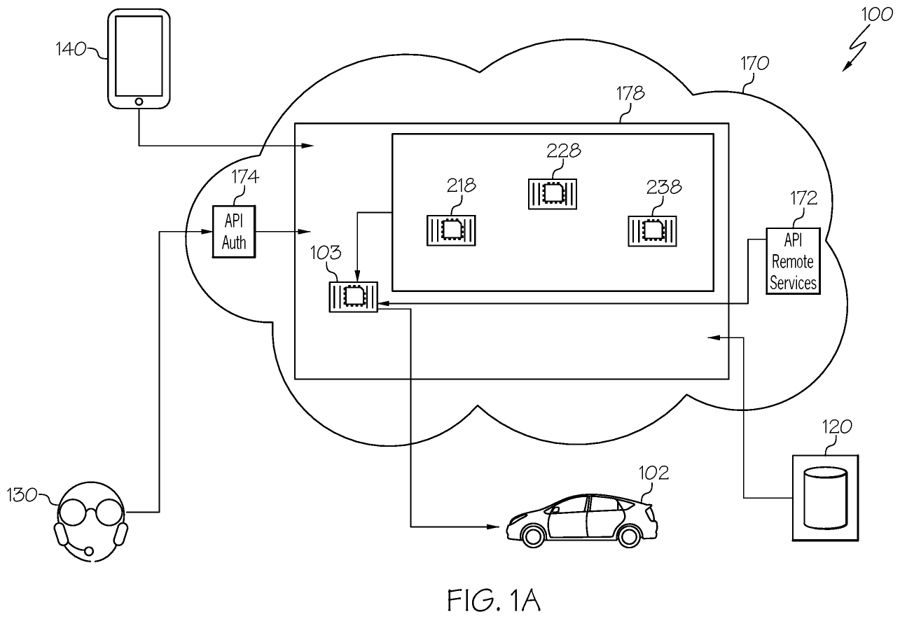

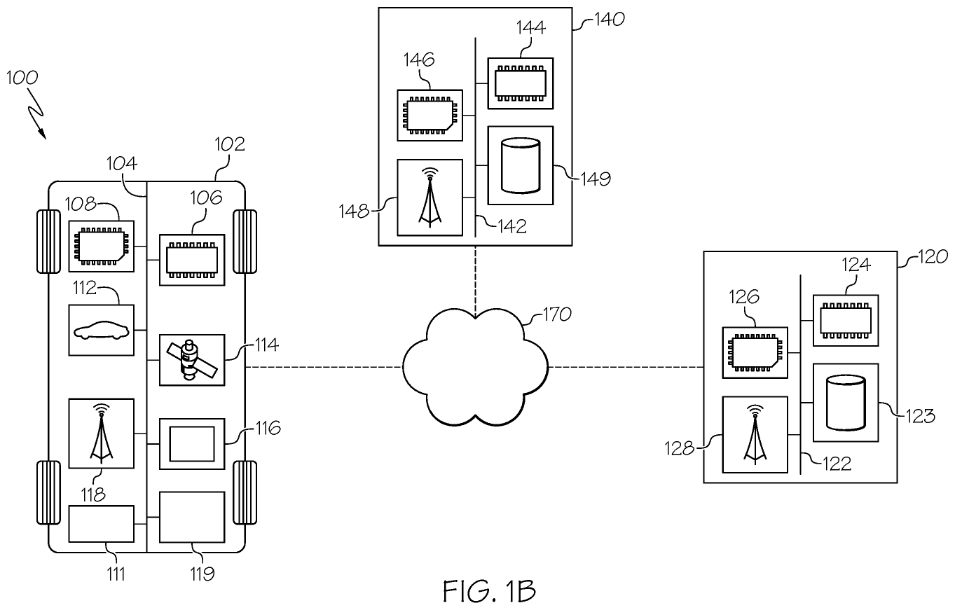

FIG. 1A depicts an exemplary system that provides remote operation of vehicles, according to one or more embodiments shown and described herewith.

In embodiments, the system 100 may include a vehicle 102, a server 120, a remote operation system 130, a personal device 140, and a network 170. While FIG. 1A depicts a single vehicle and a single personal device, the system 100 may communicate with a plurality of vehicles and a plurality of personal devices.

The server 120 may be a remote server or a local server including, but not limited to, a roadside unit, an edge server, and the like. While FIG. 1 depicts a single server, the present system may include a plurality of servers that are distributed over a larger area managed by the servers. The server 120 may provide various information through the network 170, which may provide a digital platform 178 for the system 100. The digital platform may provide various programs including an application programming interface (API) for remote services 172, an API for authorization 174.

The vehicle 102 may include an automobile or any other passenger vehicles such as, for example, a terrestrial, aquatic, and/or airborne vehicle. In some embodiments, the vehicle 102 may be an autonomous aerial vehicle that may be able to transport passengers. The vehicle 102 may be an autonomous and connected vehicle that navigates its environment with limited human input or without human input. The vehicle 102 may be equipped with internet access and share data with other devices both inside and outside the vehicle 102. The vehicle 102 may communicate with the server 120 and transmits its data to the server 120. For example, the vehicle 102 transmits data including its current location and destination, information about an occupant that it is currently transporting, information about a task that it is currently implementing, and the like.

In embodiments, a digital twin 103 of the vehicle 102 is provided in the digital platform 178. The digital platform 178 may also include a plurality of digital twins 218, 228, 238 associated with other vehicles. The digital twin 103 may allow the remote operation system 130 to remotely operate the vehicle 102. The remote operation system 130 may be authorized to remotely operate the vehicle 102 by the API for remote authorization 174. The remote operation system 130 may be authorized by the personal device 140 to remotely operate a specific vehicle (e.g., the vehicle 102). The digital twin 103 may provide a remote viewer, which allows a remote operator to see an environment surrounding the vehicle 102 (e.g., a windshield view, a side view, a rear view, a 360 view, or the like). The digital twin 103 may provide vehicle information including vehicle data from various components of the vehicle 102, including a current state of the vehicle 102. The digital twin 103 may provide control over the vehicle 102, and the remote operation system 130 may take over control of the vehicle 102. The remote operator may use a user interface (e.g., augmented lenses, computers, or the like) to control the vehicle 102. The remote operator may be a provider of the remote operation system 130, an owner of the vehicle 102, a family member of the owner, a law enforcement personnel, or anyone who is authorized to take control over the vehicle 102.

The server 120 may collect various information associated with the vehicle 102 and the occupant of the vehicle 102. The server 120 may collect authorization data corresponding the occupant of the vehicle 102. The authorization data may indicate consent for certain activities including access to the vehicle 102 or control of the vehicle 102. The server 120 may collect identification data associated with an object (e.g., a person, a robot, a vehicle, or the like) authorized to have access to the vehicle 102 or control of the vehicle 102, or authorized to pick up the occupant of the vehicle 102. The server 120 may store a list of authorized objects that are authorized to access the occupant of the vehicle 102. The identification data may include physical features, such as face, fingerprint, iris, retina, vein, hand geometry, shape, size, color, texture, material, or behavioral features, such as posture, voice, gait, or the like of the object.

The personal device 140 may be communicatively coupled to the vehicle 102 and the server 120 via the network 170. The personal device 140 may be a device for a commercial user. The personal device 140 may include, without limitation, a personal computer, a smartphone, a tablet, a personal media player, or any other electric device that includes communication functionality. A user of the personal device 140 may receive or provide various information corresponding to the authorization data or the identification data. The user may register a vehicle to the digital platform 178 for receiving a service (e.g., remote operation, concierge service, security service, or the like) provided through the digital platform 178. The server 120 may generate a route for the vehicle 102 based on the information received from the personal device 140 and the collected vehicle data form the vehicle 102. The route may be a route that transfers the occupant of the vehicle 102 to a destination location. Then, the server 120 transmits the route 160 to the vehicle 102. The vehicle 102 may follow the route 160 and display contents on the personal device 140 while following the route.

Referring now to FIG. 1B, a schematic diagram of the system 100 comprising the vehicle 102 and the server 120 is depicted. The vehicle 102 may be an automobile, a boat, a plane, or any other transportation equipment. The vehicle 102 may also or instead be a device that may be placed onboard an automobile, a boat, a plane, or any other transportation equipment. The vehicle 102 may include a processor 108, a memory 106, a driving assist module 112, a network interface 118, a location module 114, a display 116, and an input/output interface (I/O interface 119), and an identification recognition unit 111. The vehicle 102 also may include a communication path 104 that communicatively connects the various components of the vehicle 102.

The processor 108 may include one or more processors that may be any device capable of executing machine-readable and executable instructions. Accordingly, each of the one or more processors of the processor 108 may be a controller, an integrated circuit, a microchip, or any other computing device. The processor 108 is coupled to the communication path 104 that provides signal connectivity between the various components of the connected vehicle. Accordingly, the communication path 104 may communicatively couple any number of processors of the processor 108 with one another and allow them to operate in a distributed computing environment. Specifically, each processor may operate as a node that may send and/or receive data. As used herein, the phrase “communicatively coupled” means that coupled components are capable of exchanging data signals with one another such as, e.g., electrical signals via a conductive medium, electromagnetic signals via air, optical signals via optical waveguides, and the like.

Accordingly, the communication path 104 may be formed from any medium that is capable of transmitting a signal such as, e.g., conductive wires, conductive traces, optical waveguides, and the like. In some embodiments, the communication path 104 may facilitate the transmission of wireless signals, such as Wi-Fi, Bluetooth®, Near-Field Communication (NFC), and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Accordingly, the communication path 104 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory 106 is coupled to the communication path 104 and may contain one or more memory modules comprising RAM, ROM, flash memories, hard drives, or any device capable of storing machine-readable and executable instructions such that the machine-readable and executable instructions can be accessed by the processor 108. The machine-readable and executable instructions may comprise logic or algorithms written in any programming language of any generation (e.g., 1GL, 2GL, 3GL, 4GL, or 5GL) such as, e.g., machine language, that may be directly executed by the processor, or assembly language, object-oriented languages, scripting languages, microcode, and the like, that may be compiled or assembled into machine-readable and executable instructions and stored on the memory 106. Alternatively, the machine-readable and executable instructions may be written in a hardware description language (HDL), such as logic implemented via either a field-programmable gate array (FPGA) configuration or an application- specific integrated circuit (ASIC), or their equivalents. Accordingly, the methods described herein may be implemented on any conventional computer programming language, as pre-programmed hardware elements, or as a combination of hardware and software components.

The vehicle 102 may also include the driving assist module 112. The driving assist module 112 is coupled to the communication path 104 and communicatively coupled to the processor 108. The driving assist module 112 may include sensors such as LiDAR sensors, RADAR sensors, optical sensors (e.g., cameras), laser sensors, proximity sensors, location sensors (e.g., GPS modules), and the like. The data gathered by the sensors may be used to perform various driving assistance including, but not limited to advanced driver-assistance systems (ADAS), adaptive cruise control (ACC), cooperative adaptive cruise control (CACC), lane change assistance, anti-lock braking systems (ABS), collision avoidance system, automotive head-up display, autonomous driving, and/or the like.

The vehicle 102 also comprises the network interface 118 that includes hardware for communicatively coupling the vehicle 102 to the server 120. The network interface 118 can be communicatively coupled to the communication path 104 and can be any device capable of transmitting and/or receiving data via a network or other communication mechanisms. Accordingly, the network interface 118 can include a communication transceiver for sending and/or receiving any wired or wireless communication. For example, the hardware of the network interface 118 may include an antenna, a modem, a LAN port, a Wi-Fi card, a WiMAX card, a cellular modem, near-field communication hardware, satellite communication hardware, and/or any other wired or wireless hardware for communicating with other networks and/or devices. The vehicle 102 may connect with one or more other connected vehicles and/or external processing devices (e.g., the server 120) via a direct connection. The direct connection may be a vehicle-to-vehicle connection (“V2V connection”) or a vehicle-to-everything connection (“V2X connection”). The V2V or V2X connection may be established using any suitable wireless communication protocols discussed above. A connection between vehicles may utilize sessions that are time and/or location-based. In embodiments, a connection between vehicles or between a vehicle and an infrastructure may utilize one or more networks to connect which may be in lieu of, or in addition to, a direct connection (such as V2V or V2X) between the vehicles or between a vehicle and an infrastructure. By way of a non-limiting example, vehicles may function as infrastructure nodes to form a mesh network and connect dynamically/ad-hoc. In this way, vehicles may enter/leave the network at will such that the mesh network may self-organize and self-modify over time. Other non-limiting examples include vehicles forming peer-to-peer networks with other vehicles or utilizing centralized networks that rely upon certain vehicles and/or infrastructure. Still other examples include networks using centralized servers and other central computing devices to store and/or relay information between vehicles.

The location module 114 is coupled to the communication path 104 such that the communication path 104 communicatively couples the location module 114 to other modules of the vehicle 102. The location module 114 may comprise one or more antennas configured to receive signals from global positioning system (GPS) satellites. Specifically, in one embodiment, the location module 114 includes one or more conductive elements that interact with electromagnetic signals transmitted by GPS satellites. The received signal is transformed into a data signal indicative of the location (e.g., latitude and longitude) of the location module 114, and consequently, the vehicle 102.

The vehicle 102 may include the display 116 that is disposed internal and/or external to the vehicle 102. The display 116 may display contents that are requested by a user of the personal device 140. The display 116 may display the status of the vehicle including a current location, a destination location, an estimated time of arrival, or the like.

The vehicle 102 may include the I/O interface 119. The I/O interface 119 may be disposed inside the vehicle 102 such that an occupant of the vehicle 102 may see. The I/O interface 119 may allow for data to be presented to a human driver and for data to be received from the driver. For example, the I/O interface 119 may include a screen to display information to a user, speakers to present audio information to the user, and a touch screen that may be used by the user to input information. The I/O interface 119 may output information that the vehicle 102 received from the server 120. For example, the I/O interface 119 may display instructions to follow a route generated by the server 120, such as turn-by-turn instructions. The I/O interface 119 may display the same content as the one that the display 116 is displaying such that the occupant of the vehicle 102 may check what is currently displayed on the display 116 in real time.

The vehicle 102 may also include the identification recognition unit 111. The identification recognition unit 111 is coupled to the communication path 104 and communicatively coupled to the processor 108. The identification recognition unit 111 may include sensors such as LiDAR sensors, RADAR sensors, optical sensors (e.g., cameras), laser sensors, proximity sensors, location sensors (e.g., GPS modules), biometric sensors (e.g., iris recognition sensors, eye blink sensors, temperature sensors, finger print sensors, vein scanner, or the like), voice recognition sensors, motion tracking sensors, or the like. The identification recognition unit 111 may share some of the sensors with the driving assist module 112. The data gathered by the sensors may be used to identify an object in the vicinity of the vehicle 102 including, but not limited to a robot, a person, an animal, a vehicle, or the like that may be associated with an occupant of the vehicle 102. For example, the object may be able to assist the occupant to enter and/or exit the vehicle 102, or transport to and from the vehicle 102. In embodiments, the identification recognition unit 111 may provide identification data of the object outside of the vehicle 102.

In some embodiments, the vehicle 102 may be communicatively coupled to the server 120 by the network 170 via the network interface 118. The network 170 may be a wide area network, a local area network, a personal area network, a cellular network, a satellite network, and the like.

The server 120 comprises a processor 126, a memory component 124, a network interface 128, a data storage 123, and a communication path 122. Each server 120 component is similar in features to its connected vehicle counterpart, described in detail above. It should be understood that the components illustrated in FIG. 1 are merely illustrative and are not intended to limit the scope of this disclosure. More specifically, while the components in FIG. 1 are illustrated as residing within vehicle 102, this is a non-limiting example. In some embodiments, one or more of the components may reside external to vehicle 102, such as with the server 120.

The personal device 140 comprises a processor 146, a memory component 144, a network interface 148, an I/O device 149, and a communication path 142. Each component of the personal device 140 is similar in features to its connected vehicle counterpart, described in detail above. The I/O device 149 may provide an interface for the user to input a user geographic preference and/or a user population preference for her content to be displayed on the screen of the vehicle 102.

It should be understood that the components illustrated in FIG. 1B are merely illustrative and are not intended to limit the scope of this disclosure. More specifically, while the components in FIG. 1B are illustrated as residing within vehicle 102, this is a non-limiting example. In some embodiments, one or more of the components may reside external to the vehicle 102, such as with the server 120.

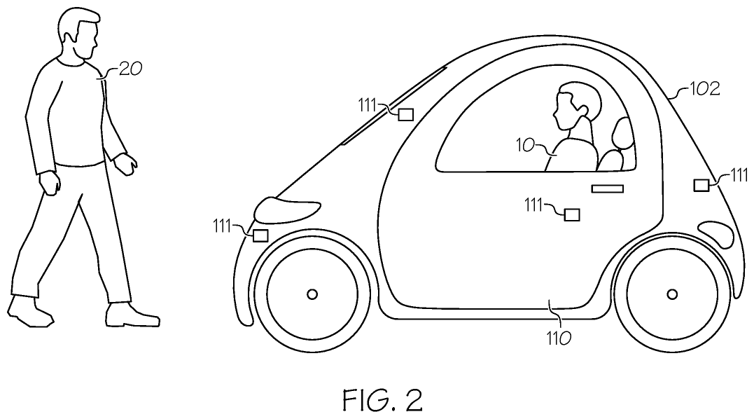

Referring now to FIG. 2, an occupant 10 may be in the vehicle 102. An object 20 (e.g., a person, a robot, an animal, a vehicle or the like) may approach the vehicle 102. For example, the object 20 may be in the vicinity of the vehicle 102 or within a distance which the identification recognition unit 111 may be able to detect the object 20. The identification recognition unit 111 provides identification data of the object 20 outside of the vehicle using the various sensors of the identification recognition unit 111. A door 110 of the vehicle 102 may be controlled to be locked and/or unlocked based on the identification data. When the door 110 is unlocked, the occupant 10 may be able to exit the vehicle 102 and/or the object 20 may retrieve the occupant 10 from the vehicle 102. In embodiments, the identification recognition unit 111 may be disposed on at least one of the front side, left side, right side, and/or rear side of the vehicle 102. The vehicle 102 may have a plurality of identification recognition unit 111. The various sensors of the identification recognition unit 111 may be disposed on the vehicle 102 where the individual sensor may operate in the intended condition.

In embodiments, the identification recognition unit 111 may also identify the occupant 10 in the vehicle 102. For example, the identification recognition unit 111 may be disposed inside of the vehicle 102. The identification data may include the identification of the occupant 10. In embodiments, the vehicle 102 may accommodate a plurality of occupants.

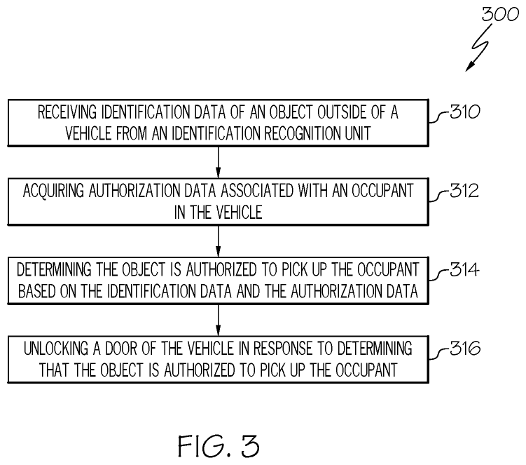

Referring now to FIG. 3, a flowchart of a method 300 that performed by the vehicle 102 and/or server 120 of FIGS. 1A-2 is depicted. At step 310 identification data of an object (e.g., the object 20) outside of a vehicle (e.g., the vehicle 102) is received from an identification recognition unit (e.g., the identification recognition unit 111). The identification data may include sensor data obtained from one or more sensors of the identification recognition unit. The sensor data from the sensors may be analyzed to identify the object.

In embodiments, identification data of an occupant (e.g., the occupant 10 of the vehicle 102) may be acquired from the identification recognition unit. The sensor data obtained from the sensors may be analyzed to identify the occupant.

At step 312, authorization data associated with the occupant in the vehicle is acquired. The authorization data may include information corresponding to identification data of authorized object. For example, the authorization data may indicate an authorized activity of the authorized object including unlocking the door of the vehicle, taking control over the vehicle, or the like that may allow the object to have an access to the occupant of the vehicle. In embodiments, authorization data associated with the occupant internal to the vehicle may be obtained based on the identification data of the occupant.

At step 314, the object is determined to be authorized to pick up the occupant based on the identification data of the object and the authorization data. For example, the authorization data corresponding to the identification data of the object may indicate that the object is authorized to have an access to the occupant and/or a control over the vehicle. In embodiments, the identification data of the occupant may be analyzed together with the identification data of the object outside of the vehicle to determine the scope of authorization based on the authorization data. For example, the object may be authorized to pick up the identified specific occupant. For another example, when the identification of the occupant is not obtained or not analyzed with the identification data of the object, the object may be authorized to pick up any occupant in the vehicle regardless of the identification of the occupant. In other words, the identification data of the object may be associated with identification of the vehicle rather than identification of the occupant. The scope of the authorization associated with the identification data of the object may be modified accordingly.

In some embodiments, if it is not determined that the object is authorized to pick up the occupant based on the identification data of the object and the authorization data, or the identification data of the object is not registered in the server 120 or the vehicle 102, the identification data of the object may be transmitted to a device of an authorized user of the occupant, e.g., a parent of the occupant. Then, the server 120 or the vehicle 102 may receive a confirmation from the device of the authorized user that the object is authorized to pick up the occupant. Then, the door of the vehicle may be unlocked.

In some embodiments, if it is not determined that the object is authorized to pick up the occupant based on the identification data of the object and the authorization data, or the identification data of the object is not registered in the server 120 or the vehicle 102, the vehicle 102 may obtain reactions of the occupant as to the object and analyze the reactions to determine whether or not the object is authorized to pick up the occupant. For example, the vehicle may obtain facial expressions, gestures, and/or gaze of the occupant using an in-vehicle camera towards the occupant. If it is determined that the occupant is greeting the object by smiling or waving her hand, the vehicle 102 or the server 120 may determine that the object is authorized to pick up the occupant based on the reactions of the occupant.

At step 316, the door of the vehicle is unlocked in response to determining that the object is authorized to pick up the occupant. For example, the authorization data indicates that the identification data of the object is authorized to pick up the occupant, the door may be unlocked to allow the object to have an access to the occupant. In embodiments, the door may automatically open when the authorization data indicates the object is authorized to pick up the occupant.

In embodiments, the door may be unlocked when a current location of the vehicle matches a destination location in addition to the determination that the object is authorized to pick up the occupant. The destination location may be received from the vehicle or a server (e.g., the server 120) prior to transporting the occupant to the destination location. The current location may be received from the vehicle or the server.

In embodiments, whether the occupant exited the vehicle may be determined after the door is unlocked. The determination may be made based on the identification recognition unit which may identify the occupant outside of the vehicle. In response to the determination that the occupant exited the vehicle, the vehicle may be driven to a base location. For example, the base location may be the same as the original location where the occupant entered the vehicle. The base location may be different from the original location. The base location may be a parking lot, a garage, a home of the occupant or the object, an office, or the like. In embodiments, the vehicle may remain at the destination location. The vehicle may be an autonomous vehicle or semi-autonomous vehicle that autonomously drives to the base location.

In embodiments, a security feature of the vehicle may be disabled in response to determining that the occupant exited the vehicle. For example, when the security feature is disabled, the system (e.g., the system 100) may allow access to the control over the vehicle; allow locking or unlocking the door without authorization data and/or identification data; allow remote operation of the vehicle outside of a course authorized by the system, or the like.

In embodiments, when the object is determined to be not authorized to pick up the occupant, the door may remain locked. In embodiments, an unauthorized attempt to open the door of the vehicle by the object may be detected when the object is not authorized to pick up the occupant based on the identification data and the authorization data. For example, when the object tries to open the door or enters into an area surrounding the vehicle not allowed to enter without proper authorization (e.g., the authorization to pick up the occupant), the unauthorized attempt to open the door of the vehicle may be detected.

In embodiments, a notification may be provided in response to detecting the unauthorized attempt. The notification may be provided by a device (e.g., the personal device 140, the vehicle 102, the remote operation system 130, or the like) in the form of an alarm sound, a visual alarm, a message, or the like. The notification may deter the unauthorized attempt to keep the occupant secure.

In embodiments, remote control of the vehicle may be allowed in response to a triggering event. The triggering event may include the unauthorized attempt to open the door of the vehicle by the object when the object is not authorized to pick up the occupant. In embodiments, the remote control of the vehicle may be provided by creating a digital twin (e.g., the digital twin 103) based on image data from the vehicle to provide augmented control of the vehicle. For example, when the object initiates the unauthorized attempt to open the door, the vehicle may be remote controlled to drive away from the object, close windows, turn on hazard lights, and/or activate various alarms.

In embodiments, the identification data may correspond to a key associated with the authorization data in a blockchain. The authorization data may be generated based on the key. The blockchain may enhance security in authorizing access to the object or remote control of the vehicle and may allow tracking history of authorization. For example, the object may be authorized to pick up the occupant when information included in the key provided by the object matches information in the system.

In addition to the various embodiments describes above associated with the authentication, the system 100 may be used to ensure security of a drunk driver. The system 100 may detect drunk driving utilizing an in-vehicle camera (e.g., the identification recognition unit 111) to detect unusual driving behavior indicating the driver is drunk. When drunk driving is detected, the system 100 may notify the remote operator. The remote operator may take over the control of the vehicle in case when the driver is severely impaired by alcohol.

In embodiments, the system 100 may be used to improve security of a stolen car. The vehicle 102 may be determined to be stolen when an in-vehicle camera (e.g., the identification recognition unit 111) detects an unauthorized user entering the vehicle 102. When the vehicle 102 is determined to be stolen, the remote operator may be notified. The remote operator may lock doors, flash hazards, prevent ignition on, or limit speed.

In embodiments, the system 100 may be used to assist people with disability (e.g., the occupant 10). For example, the vehicle 102 autonomously drives a person with disability to a destination, and the person can exit the vehicle 102 after an approved guardian (e.g., the object 20) arrives and verified by facial recognition (e.g., the identification recognition unit 111). A guardian of the person may be notified of the location of the vehicle 102 or communicate with the person in the vehicle 102.

In embodiments, the system 100 may also allow the remote operator to take over control of the vehicle when there is an emergency situation and get medical professional on the line or coach the user. The remote operator may also control climate control of the vehicle 102.

In embodiments, the system 100 may be used as tele valet parking service which the remote operator can drive to park and save user time and convenience, tele taxi service which the remote operator can drive user through approved navigation routes, car buddy service which the remote operator teaches users how to use new car features (e.g., install car seat, etc.), and digital chauffeur which the remote operator supports mobility disabled users travel anywhere freely (e.g., first and last mile communication).

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A method comprising:
receiving identification data of an object outside of a vehicle from an identification recognition unit;
acquiring authorization data associated with an occupant in the vehicle;
determining the object is authorized to pick up the occupant based on the identification data and the authorization data; and
unlocking a door of the vehicle in response to determining that the object is authorized to pick up the occupant.

2. The method of claim 1, further comprising:
receiving an input of a destination location;
acquiring a location of the vehicle;
determining that the location of the vehicle matches the location of the vehicle; and
unlocking the door of the vehicle in response to determining that the location of the vehicle matches the location of the vehicle.

3. The method of claim 1, further comprising:
determining that the occupant exited the vehicle; and
driving the vehicle to a base location in response to determining that the occupant exited the vehicle.

4. The method of claim 3, further comprising:
disabling a security feature of the vehicle in response to determining that the occupant exited the vehicle.

5. The method of claim 1, further comprising:
acquiring identification data of the occupant; and
acquiring the authorization data associated with the occupant internal to the vehicle based on the identification data of the occupant.

6. The method of claim 1, further comprising:
detecting an unauthorized attempt to open the door of the vehicle by the object when the object is not authorized to pick up the occupant based on the identification data and the authorization data; and
providing a notification in response to detecting the unauthorized attempt.

7. The method of claim 1, further comprising:
allowing remote control of the vehicle in response to a triggering event.

8. The method of claim 7, wherein:
the triggering event includes an unauthorized attempt to open the door of the vehicle by the object when the object is not authorized to pick up the occupant detected based on the identification data and the authorization data.

9. The method of claim 7, further comprising:
creating a digital twin based on image data from the vehicle to provide augmented control of the vehicle.

10. The method of claim 1, wherein:
the identification data corresponds to a key associated with the authorization data in a blockchain, and
the authorization data is generated based on the key.

11. The method of claim 1, further comprising:
operating the vehicle to drive autonomously.

12. A system comprising:
a processor configured to perform a method comprising:
receiving identification data of an object outside of a vehicle from an identification recognition unit;
acquiring authorization data associated with an occupant in the vehicle;
determining the object is authorized to pick up the occupant based on the identification data and the authorization data; and
unlocking a door of the vehicle in response to determining that the object is authorized to pick up the occupant.

13. The system of claim 12, wherein the method further comprises:
receiving an input of a destination location;
acquiring a location of the vehicle;
determining that the location of the vehicle matches the location of the vehicle; and
unlocking the door of the vehicle in response to determining that the location of the vehicle matches the location of the vehicle.

14. The system of claim 12, wherein the method further comprises:
determining that the occupant exited the vehicle; and
driving the vehicle to a base location in response to determining that the occupant exited the vehicle.

15. The system of claim 14, wherein the method further comprises:
disabling a security feature of the vehicle in response to determining that the occupant exited the vehicle.

16. The system of claim 12, wherein the method further comprises:
acquiring identification data of the occupant; and
acquiring the authorization data associated with the occupant internal to the vehicle based on the identification data of the occupant.

17. The system of claim 12, wherein the method further comprises:
detecting an unauthorized attempt to open the door of the vehicle by the object when the object is not authorized to pick up the occupant based on the identification data and the authorization data; and providing a notification in response to detecting the unauthorized attempt.

18. The system of claim 12, wherein the method further comprises:
allowing remote control of the vehicle in response to a triggering event.

19. The system of claim 18, wherein:
the triggering event includes an unauthorized attempt to open the door of the vehicle by the object when the object is not authorized to pick up the occupant detected based on the identification data and the authorization data.

20. The system of claim 18, wherein the method further comprises:
creating a digital twin based on image data from the vehicle to provide augmented control of the vehicle.
